(19) United States
(12) Patent Application Publication
(10) Pub. No.: US 2007/0274767 A1
(43) Pub. Date: Nov. 29, 2007

(54) Permanent ink refill and permanent ink refillable writing instrument articles and methods

(76) Inventor: Yair Greenberg, Woodland Hills, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/440,210

(22) Filed: May 24, 2006

(51) Int. Cl. B43K 8/06; B43K 5/00

(52) U.S. Cl. 401/198; 401/202

(57) ABSTRACT

A permanent ink refill, for a permanent ink refillable writing instrument which is able to enable the permanent ink refill to be inserted therein. The permanent ink refill includes a generally tubular portion, containing a supply of permanent ink, and a tip portion, for enabling the dispensing of the permanent ink upon insertion of the permanent ink refill therein and use thereof in the permanent ink refillable pen. A permanent ink refillable writing instrument is able to enable a permanent ink refill to be inserted therein. The permanent ink refillable writing instrument includes a housing, including a barrel portion, for enabling a permanent ink refill to be insertable therein, and a tip portion, having an opening at the end thereof, extending from the barrel portion, for enabling dispensing of permanent ink from the permanent ink refill therethrough.

### BACKGROUND OF THE INVENTION

1. Field of the Invention

This invention is generally related to refillable pens and refills therefor, and more particularly, to articles and methods for providing a permanent ink refill and a permanent ink refillable writing instrument.

2. General Background and State of the Art

A permanent marker includes permanent ink. However, a permanent marker is disposable, is not reusable once the supply of ink runs out, and is not able to receive a permanent ink refill to enable continued writing with permanent ink. A rollerball pen is able to receive a refill so as to be reusable, but the refill is a rollerball refill, which does not enable writing with permanent ink.

Therefore, there has been identified a continuing need to provide a permanent ink refill, which is able to fit in a permanent ink refillable marker, and in a rollerball pen to convert the rollerball pen to a refillable permanent ink rollerball pen, for enabling writing and continued writing with permanent ink.

### INVENTION SUMMARY

Briefly, and in general terms, the present invention, in a preferred embodiment by way of example, is directed to a permanent ink refill, for a permanent ink refillable writing instrument which is able to enable the permanent ink refill to be inserted therein. The permanent ink refill includes a generally tubular portion, containing a supply of permanent ink, and a tip portion, for enabling the dispensing of the permanent ink upon insertion of the permanent ink refill therein and use thereof in the permanent ink refillable writing instrument. The present invention is also directed, in a preferred embodiment by way of example, to a permanent ink refillable writing instrument, which is able to enable a permanent ink refill to be inserted therein. The permanent ink refillable writing instrument includes a housing, including a barrel portion, for enabling a permanent ink refill to be insertable therein, and a tip portion, having an opening at the end thereof, extending from the barrel portion. It further includes a permanent ink refill, insertable in the housing, including a generally tubular portion, containing a supply of permanent ink, insertable in the housing barrel portion, and a tip portion, for enabling dispensing of the permanent ink therethrough upon insertion of the permanent ink refill therein and use of the permanent ink refillable writing instrument, extendable through the housing tip portion end opening.

In accordance with other aspects of the invention, the permanent ink refill is able to fit in a rollerball pen, to convert the rollerball pen to a permanent ink refillable rollerball, for enabling writing with permanent ink therewith.

These and other aspects and advantages of the invention will become apparent from the following detailed description and the accompanying drawings, which illustrate by way of example the features of the invention.

### BRIEF DESCRIPTION OF THE DRAWINGS

FIG. 1 is an elevational view of a first embodiment of a permanent ink refill in the present invention;

FIG. 2 is an elevational view of a second embodiment of a permanent ink refill in the invention;

FIG. 3 is an elevational view of a third embodiment of a permanent ink refill in the invention;

FIG. 4 is an elevational view of a fourth embodiment of a permanent ink refill, with a cover, in the invention;

FIG. 5 is an elevational view of a permanent ink refillable writing instrument in a marker embodiment, with a cover, in the invention;

FIG. 6 is an elevational view of a permanent ink refillable writing instrument in a marker embodiment, with a cover covering the tip, in the invention;

FIG. 7 is an elevational view of a permanent ink refillable writing instrument, in a rollerball pen embodiment thereof, with a cover, and with a permanent ink refill shown in dashed lines therein, in the invention; and

FIG. 8 is an elevational view of a permanent ink refillable writing instrument, in a rollerball pen embodiment thereof, with a cover covering the tip, and with a permanent ink refill shown in dashed lines therein, in the invention.

### DETAILED DESCRIPTION OF THE PREFERRED EMBODIMENTS

The articles and methods herein include an invention of a permanent ink refill, and an invention of a permanent ink refillable writing instrument.

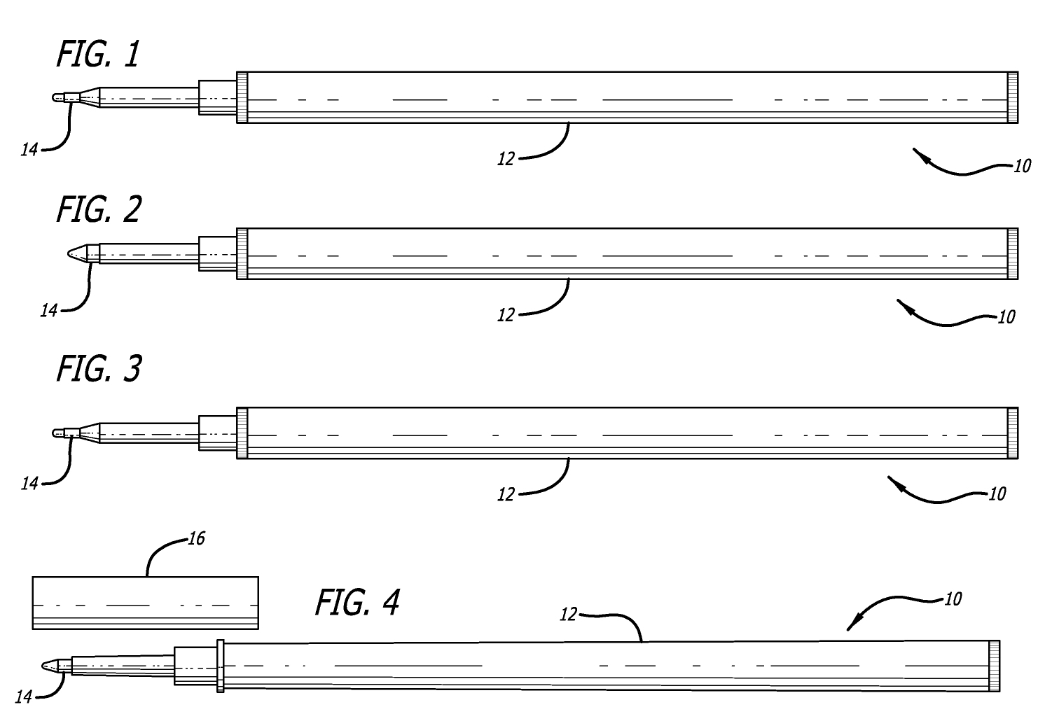

The permanent ink refill 10 of the invention, as described herein and illustrated in FIGS. 1-4, is able to be inserted in a writing instrument which comprises a permanent ink refillable writing instrument. It enables the refilling of inexpensive pens and expensive pens with permanent ink. The permanent ink refill 10 includes a generally tubular portion 12, containing a supply of permanent ink. The generally tubular portion 12 may be comprised of plastic or metal. The permanent ink refill 10 further includes a tip portion 14, for enabling the dispensing of the permanent ink upon insertion of the permanent ink refill 10 therein and use thereof in the permanent ink refillable writing instrument. The tip portion 14 may be comprised of fiber, and may be a fine width tip, a medium width tip, or a wide width tip. The permanent ink refill 10, as shown in FIG. 4, may also include a cover 16 for covering the tip portion 14. The permanent ink refillable writing instrument may comprise a marker or a rollerball pen. The permanent ink refill 10 holds permanent ink inside, and is able to fit a refillable rollerball pen, converting a refillable rollerball pen to enable writing with permanent ink, and is able to fit in a housing for a permanent ink refillable marker. The permanent ink in the permanent ink refill 10 may comprise any color, such as black, blue, red or green permanent ink.

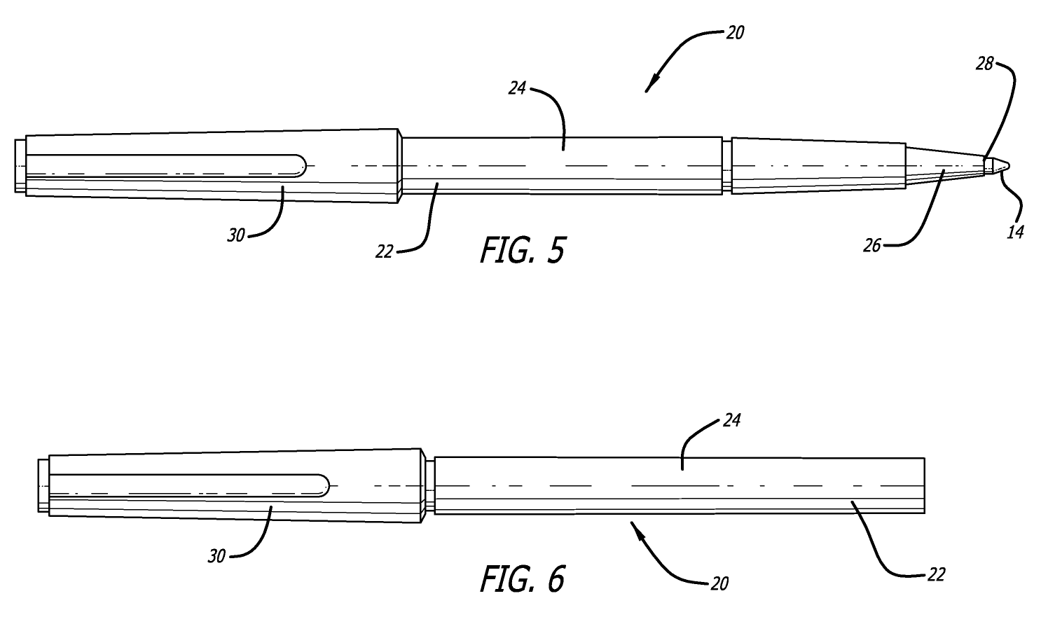

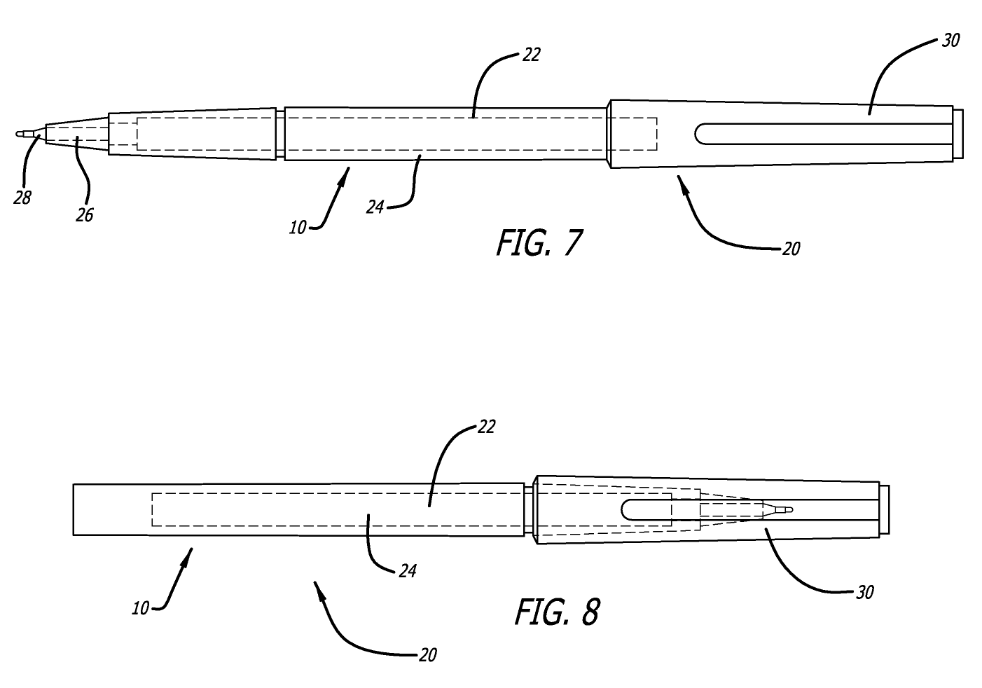

The permanent ink refillable writing instrument 20 of the invention, as shown in FIGS. 4-8 and described herein, is able to enable a permanent ink refill to be inserted therein. The permanent ink refillable writing instrument 20 includes a housing 22, including a barrel portion 24, for enabling a permanent ink refill to be insertable therein, and a tip portion 26, having an opening 28 at the end thereof, extending from the barrel portion 24. The housing 22 may comprise a marker writing instrument housing, as seen in FIGS. 5-6, or a rollerball pen housing, as in FIGS. 7-8. The permanent ink refillable writing instrument 20, as illustrated in FIGS. 5-8, may also include a cover 30 for covering the tip portion 26. Also, the permanent ink refillable writing instrument 20 includes the permanent ink refill 10, as seen in FIGS. 1-8, insertable in the housing 22. The permanent ink refill 10 includes the generally tubular portion 12, containing a supply of permanent ink, insertable in the housing barrel portion 24, and the tip portion 14, for enabling dispensing of the permanent ink therethrough upon insertion of the permanent ink refill 10 therein and use of the permanent ink refillable pen 20, which is extendable through the housing tip portion end opening 28. The generally tubular portion 12 of the permanent ink refill 10 may be comprised of plastic or metal. The permanent ink refill tip portion 14 may be comprised of fiber. It may comprise a fine width tip, a medium width tip, or a wide width tip. The permanent ink in the permanent ink refill 10 may comprise any color, such as black, blue, red, or green permanent ink.

While the particular permanent ink refill and permanent ink refillable writing instrument as shown and disclosed in detail herein are fully capable of obtaining the objects and providing the advantages previously stated, it is to be understood that they are merely illustrative of the presently preferred embodiment of the invention, and that no limitations are intended to the details of construction or design shown herein other than as described in the appended claims.

I claim :

1. A permanent ink refill, for a permanent ink refillable writing instrument which is able to enable the permanent ink refill to be inserted therein, comprising:
a generally tubular portion, containing a supply of permanent ink; and
a tip portion, for enabling the dispensing of the permanent ink upon insertion of the permanent ink refill therein and use thereof in the permanent ink refillable writing instrument.

2. A permanent ink refill as in claim 1, wherein the generally tubular portion is comprised of plastic.

3. A permanent ink refill as in claim 1, wherein the generally tubular portion is comprised of metal.

4. A permanent ink refill as in claim 1, wherein the tip portion is comprised of fiber.

5. A permanent ink refill as in claim 1, wherein the tip portion comprises a fine width tip.

6. A permanent ink refill as in claim 1, wherein the tip portion comprises a medium width tip.

7. A permanent ink refill as in claim 1, wherein the tip portion comprises a wide width tip.

8. A permanent ink refill as in claim 1, wherein the permanent ink comprises black permanent ink.

9. A permanent ink refill as in claim 1, wherein the permanent ink comprises blue permanent ink.

10. A permanent ink refill as in claim 1, wherein the permanent ink comprises red permanent ink.

11. A permanent ink refill as in claim 1, wherein the permanent ink comprises green permanent ink.

12. A permanent ink refill as in claim 1, wherein the permanent ink refillable writing instrument comprises a marker.

13. A permanent ink refill as in claim 1, wherein the permanent ink refillable writing instrument comprises a rollerball pen.

14. A permanent ink refillable writing instrument which is able to enable a permanent ink refill to be inserted therein, comprising:
a housing, including a barrel portion, for enabling a permanent ink refill to be insertable therein, and a tip portion, having an opening at the end thereof, extending from the barrel portion; and
a permanent ink refill, insertable in the housing, including a generally tubular portion, containing a supply of permanent ink, insertable in the housing barrel portion, and a tip portion, for enabling dispensing of the permanent ink therethrough upon insertion of the permanent ink refill therein and use of the permanent ink refillable writing instrument, extendable through the housing tip portion end opening.

15. A permanent ink refillable writing instrument as in claim 14, wherein the housing comprises a marker housing.

16. A permanent ink refillable writing instrument as in claim 14, wherein the housing comprises a rollerball pen housing.

17. A permanent ink refillable writing instrument as in claim 14, wherein the generally tubular portion of the permanent ink refill is comprised of plastic.

18. A permanent ink refillable writing instrument as in claim 14, wherein the generally tubular portion of the permanent ink refill is comprised of metal.

19. A permanent ink refillable writing instrument as in claim 14, wherein the permanent ink refill tip portion is comprised of fiber.

20. A permanent ink refillable writing instrument as in claim 14, wherein the permanent ink refill tip portion comprises a fine width tip.

21. A permanent ink refillable writing instrument as in claim 14, wherein the permanent ink refill tip portion comprises a medium width tip.

22. A permanent ink refillable writing instrument as in claim 14, wherein the permanent ink refill tip portion comprises a wide width tip.

23. A permanent ink refillable writing instrument as in claim 14, wherein the permanent ink comprises black permanent ink.

24. A permanent ink refillable writing instrument as in claim 14, wherein the permanent ink comprises blue permanent ink.

25. A permanent ink refillable writing instrument as in claim 14, wherein the permanent ink comprises red permanent ink.

26. A permanent ink refillable writing instrument as in claim 14, wherein the permanent ink comprises green permanent ink.

27. A method of enabling a permanent ink refill to be insertable in a permanent ink refillable writing instrument, in an article which comprises a permanent ink refill, for a permanent ink refillable writing instrument which is able to enable the permanent ink refill to be inserted therein, wherein the permanent ink refill includes a generally tubular portion, containing a supply of permanent ink, and a tip portion, for enabling the dispensing of the permanent ink upon insertion of the permanent ink refill therein and use thereof in the permanent ink refillable writing instrument, wherein the method comprises:
enabling a permanent ink refill to be insertable in a permanent ink refillable writing instrument.

28. A method of enabling insertion of a permanent ink refill therein, in an article which comprises a permanent ink refillable writing instrument, which is able to enable a permanent ink refill to be inserted therein, which includes a housing, including a barrel portion, for enabling a permanent ink refill to be insertable therein, and a tip portion, having an opening at the end thereof, extending from the barrel portion, and a permanent ink refill, insertable in the housing, including a generally tubular portion, containing a supply of permanent ink, insertable in the housing barrel portion, and a tip portion, for enabling dispensing of the permanent ink therethrough upon insertion of the permanent ink refill therein and use of the permanent ink refillable writing instrument, extendable through the housing tip portion end opening, wherein the method comprises:
enabling a permanent ink refillable writing instrument to have a permanent ink refill inserted therein.
